(19) United States
(12) Patent Application Publication
(10) Pub. No.: US 2023/0254426 A1
(43) Pub. Date: Aug. 10, 2023

(54) IMAGE READING DEVICE

(71) Applicant: TOSHIBA TEC KABUSHIKI KAISHA, Tokyo (JP)

(72) Inventor: Hiromasa Tanaka, Sunto Shizuoka (JP)

(21) Appl. No.: 17/668,407

(22) Filed: Feb. 10, 2022

(51) Int. Cl. H04N 1/12; H04N 1/00

(52) U.S. Cl. CPC H04N 1/1225; H04N 1/00185; H04N 1/00803

(57) ABSTRACT

An image reading device includes an image reading unit and a control unit. The image reading unit reads the image information of the reading target as target image information. The control unit controls the image reading unit. The control unit detects whether or not the image information of the streak not included in the reading target is included in the target image information each time the target image information is read by the image reading unit, and performs the process related to suppression of streak occurrence based on the number of times of streak appearance in which the image information of the streak is included in the target image information.

### FIELD

Embodiments described herein relate generally to an image reading device.

### BACKGROUND

In the related art, there is known an image reading device having an image reading unit that reads image information of a reading target as target image information and detecting whether or not image information indicating the streak not included in the reading target is included in the target image information. If such an image reading device includes image information indicating the streak in the target image information, in many cases, an image process of removing the image information indicating the streak from the target image information is performed. However, in the image reading device, if such image process is performed, a time required for reading the target image information from the reading target increases, and thus, there is a situation that efficient operation may not be performed. One of the causes for such a situation is that the image reading device cannot remove the cause that the image information indicating the streak is included in the target image information at an appropriate timing.

### DESCRIPTION OF THE DRAWINGS

FIG. 1 is an external view illustrating an overall configuration example of an image reading device 100 of an embodiment.

FIG. 2 is a diagram illustrating an example of a configuration of an image reading unit 150.

FIG. 3 is a diagram illustrating an example of a functional configuration of the image reading device 100.

FIG. 4 is a diagram illustrating an example of an image indicated by target image information read from a reading target by the image reading unit 150.

FIG. 5 is a diagram illustrating an example of a data flow after reading the target image information in the image reading device 100.

FIG. 6 is a diagram illustrating an example of a data flow after reading the target image information if the image reading device 100 performs the same operation as the image reading device in the related art.

FIG. 7 is a diagram illustrating an example of a flow of an image information reading process in a case of performing a process of forming an image indicated by image information of a reading target on a print medium.

FIG. 8 is a diagram illustrating an example of a histogram illustrating a streak appearance frequency for each of seven partial image regions.

FIG. 9 is a diagram illustrating another example of the histogram illustrating the streak appearance frequency for each of the seven partial image regions.

FIG. 10 is a diagram illustrating an example of a maintenance promotion image for a partial reading region RF.

FIG. 11 is a diagram illustrating an example of a maintenance promotion image for all of the image information reading regions PA.

FIG. 12 is a diagram illustrating an example of a flow of an initialization process performed by a control unit 300.

FIG. 13 is a diagram illustrating an example of a histogram illustrating a streak appearance frequency in the partial image region RAR in each of seven time zones.

FIG. 14 is a diagram illustrating another example of a histogram illustrating a streak appearance frequency in a partial image region RER in each of seven time zones.

### DETAILED DESCRIPTION

In general, according to one embodiment, an image reading device includes an image reading unit and a control unit. The image reading unit reads image information of a reading target as target image information. The control unit controls the image reading unit. The control unit detects whether or not the image information indicating a streak not included in the reading target is included in the target image information each time the target image information is read by the image reading unit and performs the process related to suppression of streak occurrence based on the number of times of streak appearance in which the image information indicating the streak is included in the target image information.

Hereinafter, the image reading device of the embodiment will be described with reference to the drawings. In each figure, the same configurations are denoted by the same reference numerals. As an example of the image reading device of the embodiment, an image reading device 100 will be described as an example.

(Configuration of Image Reading Device)

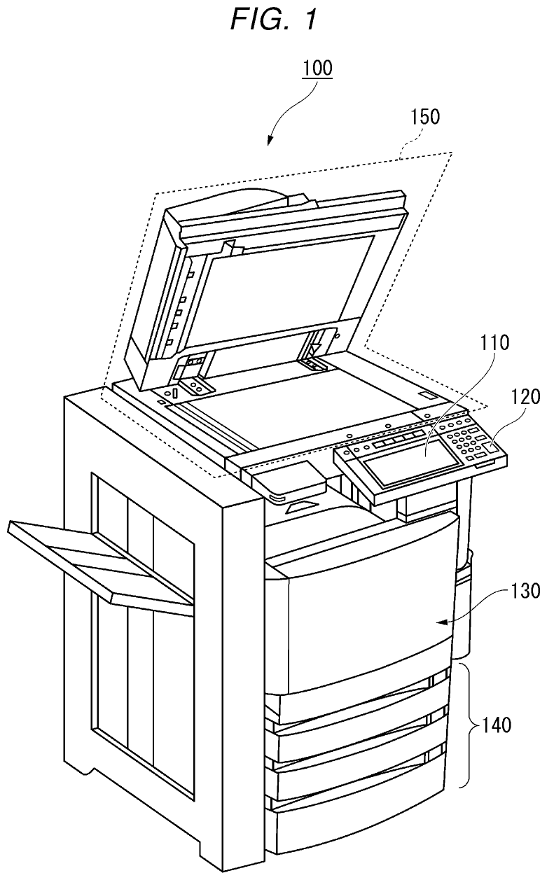

A configuration of an image reading device 100 will be described with reference to FIG. 1.

FIG. 1 is an external view illustrating an overall configuration example of the image reading device 100 of an embodiment. The image reading device 100 may be any device as long as the image reading device has a function of reading image information of a reading target. The image reading device 100 is, for example, a multifunction device, a scanner, a facsimile (FAX), or the like. As an example, as illustrated in FIG. 1, a case where the image reading device 100 is a multifunction device will be described. In this case, the image reading device 100 has a function of reading the image information of the reading target and at least a function of forming an image indicated by the image information on a print medium.

The reading target may be, for example, a paper on which an image including figures, characters, or the like is drawn or may be another planar object such as a cloth on which the image is drawn, a three-dimensional structure, or the like. The image information of the reading target is information indicating an image drawn on the reading target. As an example, a case where a paper on which an image including figures, characters, and the like is drawn is the reading target will be described.

The image reading device 100 includes a display 110, a control panel 120, an image formation unit 130, a print medium accommodation unit 140, and an image reading unit 150.

The display 110 is a display device that displays an image such as a liquid crystal display or an organic electro luminescence (EL) display. The display 110 displays an image including various types of information on the image reading device 100.

The control panel 120 has a plurality of buttons. The control panel 120 accepts operations of a user. The control panel 120 outputs a signal corresponding to the operation performed by the user to the control unit of the image reading device 100. The display 110 and the control panel 120 may be configured as an integrated touch panel.

The image formation unit 130 may be a device for fixing a toner image, may be an inkjet type device, or may be a device in which another method is adopted as a method of forming an image on a print medium. The image formation unit 130 forms an image on the print medium based on image information generated by the image reading unit 150 or image information received via a communication path. The print medium is, for example, a printing paper, a sticker mount paper, or the like, but not limited thereto. The image formation unit 130 forms an image by, for example, the following process. The image formation unit 130 forms an electrostatic latent image on a photoconductor drum based on the image information. The image formation unit 130 forms a visible image by adhesion of a developer to the electrostatic latent image. The developer is, for example, toner. The image formation unit 130 transfers the visible image to the print medium. The image formation unit 130 fixes the visible image transferred to the print medium on the print medium by heating and pressurizing the print medium. The print medium on which the image is formed may be a print medium accommodated in the print medium accommodation unit 140 or may be a print medium by manual feed.

The print medium accommodation unit 140 accommodates the print medium used for image formation in the image formation unit 130.

The image reading unit 150 reads the image information of the reading target as light and dark. The image reading unit 150 stores the read image information. The stored image information may be transmitted to another information process device via a network. The image of the stored image information may be formed on the print medium by the image formation unit 130. For the convenience of description, the image information read from the reading target by the image reading unit 150 will be referred to as target image information.

(Configuration of Image Reading Device)

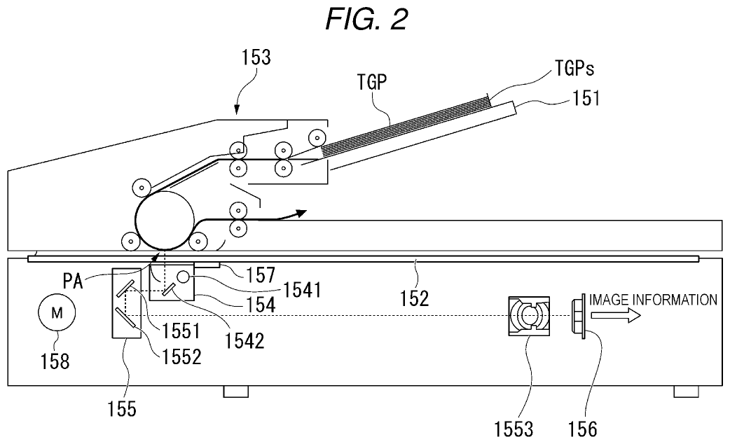

Hereinafter, a configuration of the image reading unit 150 will be described with reference to FIG. 2. FIG. 2 is a diagram illustrating an example of the configuration of the image reading unit 150.

The image reading unit 150 includes a tray 151, a glass table 152, a conveying unit 153, a first optical system 154, a second optical system 155, an image sensor 156, a carriage 157, and a motor 158.

The tray 151 is a tray on which one or more reading targets are loaded. If the operation mode of the image reading unit 150 is a scan reading mode, one-sheet or more-sheet reading targets loaded on the tray 151 are conveyed by the conveying unit 153. The scan reading mode is an operation mode of allowing the image reading unit 150 to read the image information of the reading target as the target image information by the conveyance of the reading target by the conveying unit 153, among the operation modes of the image reading unit 150. In the example illustrated in FIG. 2, a bundle TGPs of reading targets TGP are loaded on the tray 151.

The glass table 152 is a transparent glass table on which the reading target is mounted. If the operation mode of the image reading unit 150 is a manual reading mode, the reading target mounted on the glass table 152 is read as the target image information by the image reading unit 150 while being mounted on the glass table 152. The manual reading mode is an operation mode of allowing the image reading unit 150 to read the image information of the reading target mounted on the glass table 152 as the target image information among the operation modes of the image reading unit 150. For this reason, in the manual reading mode, the conveyance of the reading target by the conveying unit 153 is not performed.

The conveying unit 153 includes a plurality of rollers. If the operation mode of the image reading unit 150 is the scan reading mode, the conveying unit 153 conveys the reading targets loaded on the tray 151 one by one by the plurality of rollers and sequentially passes the image information reading regions PA. The image information reading region PA is a predetermined region on the glass table 152. The image information reading region PA is a rectangular region extending in a main scanning direction, which will be described later. The image information reading region PA may be configured not to be included in the region on which the reading target is mounted in the manual reading mode on the glass table 152 or may be configured to be included in the region. As an example, a case where the image information reading region PA is configured not to be included in the region on the glass table 152 will be described. In this case, among the regions on the glass table 152, the region not included in both the image information reading region PA and the region may be divided by metal, resin, coating, or the like or may not be divided.

The conveying unit 153 is, for example, an Automatic Document Feeder (ADF). The conveying unit 153 may be a duplexing automatic document feeder (DADF), may be a reversing automatic document feeder (RADF), or may be another type of automatic document feeder (ADF).

The first optical system 154 includes a light source 1541 and one or more reflecting members. In the example illustrated in FIG. 2, the first optical system 154 includes one reflecting member 1542 as the one or more reflecting members.

The light source 1541 may be any light source as long as the light source is a rod-shaped light source extending in the main scanning direction. The light source 1541 is, for example, a rod-shaped lamp or a light emitting diode (LED) extending in the main scanning direction. The light source 1541 is movably arranged under the glass table 152 together with the reflecting member 1542 in a sub-scanning direction. Accordingly, the light source 1541 can irradiate the reading target passing through the image information reading region PA from under the glass table 152 or the reading target mounted on the glass table 152 with light according to the position of the light source 1541. The main scanning direction is a direction parallel to an upper surface of the glass table 152 and perpendicular to a conveying direction in which the reading target is conveyed by the conveying unit 153. The sub-scanning direction is a direction parallel to the upper surface of the glass table 152 and perpendicular to the main scanning direction.

The reflecting member 1542 is a member that further reflects the reflected light obtained by reflecting the light emitted from the light source 1541 by the reading target toward the second optical system 155. The reflecting member 1542 may be any member as long as the reflecting member is a member that can further reflect the reflected light obtained by reflecting the light emitted from the light source 1541 by the reading target toward the second optical system 155. The reflecting member 1542 is, for example, a reflecting mirror.

The second optical system 155 includes one or more reflecting members for reflecting the reflected light incident from the first optical system 154 toward the image sensor 156. In the example illustrated in FIG. 2, the second optical system 155 includes two reflecting members of a reflecting member 1551 and a reflecting member 1552 as one or more such reflecting members.

The reflecting member 1551 is a member for reflecting the reflected light incident from the first optical system 154 toward the reflecting member 1552. The reflecting member 1551 may be any member as long as the reflecting member can reflect the reflected light incident from the first optical system 154 toward the reflecting member 1552. The reflecting member 1552 is, for example, a reflecting mirror.

The reflecting member 1552 is a member for reflecting the reflected light incident from the reflecting member 1551 toward the image sensor 156. Any member may be used as long as the member can reflect the reflected light incident from the reflecting member 1551 toward the image sensor 156. The reflecting member 1552 is, for example, a reflecting mirror.

The second optical system 155 further includes a collimator 1553 that collimates the reflected light reflected from the reflecting member 1552 toward the image sensor 156. The second optical system 155 may not be provided with the collimator 1553.

The image sensor 156 converts the reflected light incident from the second optical system 155 into an electric signal and outputs the converted electric signal as image information of the reading target. The image sensor 156 is a linear image sensor, for example, a charge coupled device (CCD) sensor, but not limited thereto.

If the operation mode of the image reading unit 150 is the manual reading mode, the carriage 157 scans the first optical system 154 in the sub-scanning direction. If the operation mode of the image reading unit 150 is the scan reading mode, the carriage 157 allows the first optical system 154 to stand by at a predetermined standby position. The standby position may be any position as long as the standby position is a position where the light source 1541 can irradiate the image information reading region PA with light and the reflecting member 1542 can receive the reflected light from the reading target. In FIG. 2, in order to simplify the figure, the carriage 157 is drawn as a square object adjacent to the first optical system 154.

The motor 158 drives the carriage 157 via a plurality of gears and the like. In FIG. 2, the plurality of gears and the like are omitted in order to simplify the figure. The motor 158 is, for example, a stepping motor, but not limited thereto.

With the above-described configuration, the image reading unit 150 allows the reflected light obtained by exposing and scanning the image of the reading target by the light emission of the light source 1541 to be incident on the image sensor 156 in the scan reading mode or the manual reading mode. Accordingly, the image reading unit 150 converts the image of the reading target into an electric signal, converts the converted electric signal into a luminance signal configured with colors of R, G, and B, and outputs the converted luminance signal as image information. The image information is in a raster format where pixels are arranged for each main scanning line and the lines are arranged in the sub-scanning direction.

In some cases, the image information of the streak not drawn on the reading target (that is, the streak not included in the reading target) may be included in the target image information read from the reading target by the image reading unit 150. This is caused by the adhesion of the contaminants or the like to the image information reading region PA, the adhesion of the contaminants or the like to the first optical system 154, or the like. In many image reading devices different from the image reading device 100, if the image information indicating the streak is included in the read target image information, the image process of removing the image information indicating the streak from the read target image information is performed. However, in some cases, in the image reading device, if such image process is performed, the time required for reading the target image information from the reading target increases, and thus, efficient operation may not be performed. One of the causes of such a situation is that the image reading device cannot remove the cause that the image information indicating the streak is included in the read target image information at an appropriate timing.

Therefore, each time the target image information is read by the image reading unit 150, the image reading device 100 detects whether or not the image information indicating streaks that are not included in the reading target is included in the read target image information. By performing such detection each time the target image information is read by the image reading unit 150, the image reading device 100 counts the number of times that the image information indicating the streak is included in the read target image information as the number of times of streak appearance. The image reading device 100 performs a process based on the number of times of streak appearance counted each time the target image information is read by the image reading unit 150. The process is, for example, a process of displaying an image for prompting the user of the image reading device 100 for the maintenance of the image reading unit 150, a process of notifying a request for the maintenance to a maintenance company of the image reading device 100, and the like. The process based on the number of times of streak appearance may be paraphrased as a process related to maintenance of the image reading unit 150, a process of promoting the maintenance of the image reading unit 150, and the like. As a result, the image reading device 100 can remove the cause of the image information indicating the streak being included in the target image information read by the image reading unit 150 at an appropriate timing. As a result, the image reading device 100 can prevent the time required for reading the target image information from the reading target from unnecessarily increasing, and thus, can perform efficient operations.

For the convenience of description, the streaks that are not included in the reading target will be simply referred to as streaks. For the convenience of description, the image information indicating the streak will be referred to as streak image information.

(Functional Configuration of Image Reading Device)

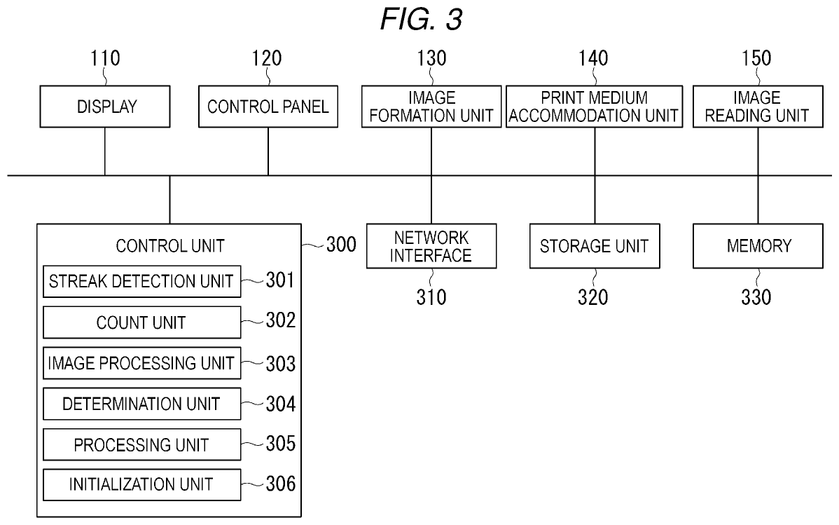

A functional configuration of the image reading device 100 will be described with reference to FIG. 3.

FIG. 3 is a diagram illustrating an example of the functional configuration of the image reading device 100.

The image reading device 100 includes a display 110, a control panel 120, an image formation unit 130, a print medium accommodation unit 140, and an image reading unit 150. Further, the image reading device 100 includes a control unit 300, a network interface 310, a storage unit 320, and a memory 330. Each of the functional units included in the image reading device 100 is communicably connected via a system bus.

The display 110, the control panel 120, the image formation unit 130, the print medium accommodation unit 140, and the image reading unit 150 are described in the same manner as described above, and thus, the description thereof will be omitted. Hereinafter, each of the control unit 300, the network interface 310, the storage unit 320, and the memory 330 will be described.

The control unit 300 includes a central processing unit (CPU) of the image reading device 100. The control unit 300 controls the operation of each of the functional units of the image reading device 100. The control unit 300 executes various processes by executing the program. The control unit 300 acquires instruction input by the user from the control panel 120. That is, the control unit 300 accepts an operation from the user by the control panel 120. The control unit 300 executes the control process based on the acquired instruction.

The control unit 300 includes, for example, a streak detection unit 301, a count unit 302, an image processing unit 303, a determination unit 304, a processing unit 305, and an initialization unit 306. These functional units included in the control unit 300 are realized by the CPU included in the control unit 300 executing various programs. Some or all of the functional units may be hardware functional units such as large scale integration (LSI) and application specific circuit (ASIC).

The streak detection unit 301 detects whether or not the streak image information is included in the target image information read from the reading target by the image reading unit 150.

The count unit 302 counts the number of times of detection of the streak image information by the streak detection unit 301 as the number of times of streak appearance.

The image processing unit 303 performs various image processes in the image reading device 100. The image processing unit 303 performs an image process such as conversion of synchronous system and asynchronous system of the target image information read by the image reading unit 150 and removal of streak image information from the target image information.

The determination unit 304 performs various determinations in the image reading device 100.

The processing unit 305 performs a process based on the number of times of streak appearance in the image reading device 100.

The initialization unit 306 initializes the number of times of streak appearance in the image reading device 100. The initialization of the number of times of streak appearance is specifically to set the value of the number of times of streak appearance to 0.

The network interface 310 transmits and receives data to and from other devices. The network interface 310 operates as an input interface and receives the data transmitted from other devices. Further, the network interface 310 operates as an output interface and transmits the data to other devices.

The storage unit 320 is, for example, an auxiliary storage device such as a hard disk or a solid state drive (SSD). The storage unit 320 stores various types of information. For example, the storage unit 320 stores a program executed by the control unit 300.

The memory 330 is, for example, a random access memory (RAM). The memory 330 temporarily stores information used by each of the functional units included in the image reading device 100. In addition, the memory 330 may store the target image information read by the image reading unit 150, the programs for operating each of the functional units, and the like.

(Method of Detecting Streak Image Information by Streak Detection Unit)

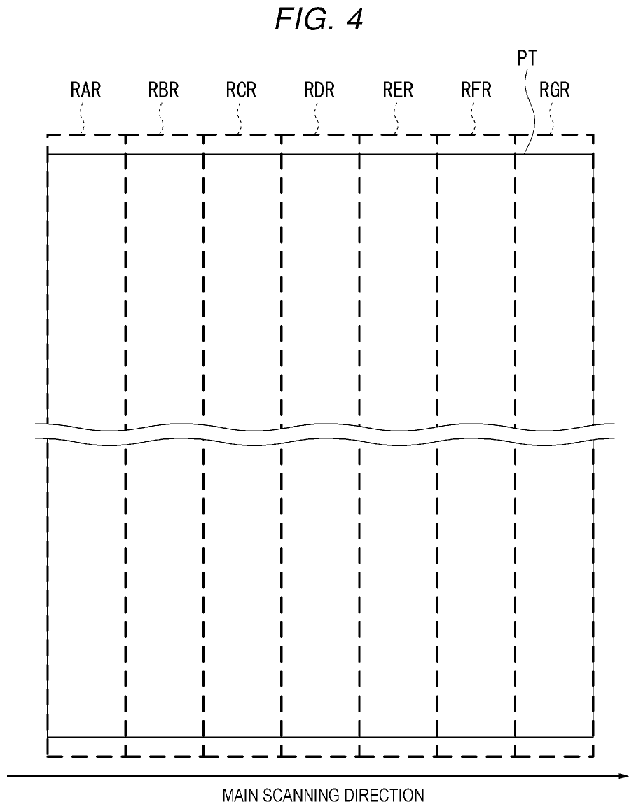

A method of detecting the streak image information by the streak detection unit 301 will be described with reference to FIG. 4. FIG. 4 is a diagram illustrating an example of an image indicated by the target image information read from the reading target by the image reading unit 150. An image PT illustrated in FIG. 4 is an example of the image indicated by the target image information read from the reading target by the image reading unit 150.

In the image reading device 100, the above-mentioned image information reading region PA is virtually divided into a plurality of rectangular partial reading regions arranged in a main scanning direction. In other words, each of a plurality of virtual partial regions is virtually allocated to the image information reading region PA so that the plurality of virtual partial regions are arranged in the main scanning direction. Some or all of the plurality of partial reading regions may be configured to have the same size as each other, may be configured to have different sizes from each other, may be configured to have the same shape as each other, or may be configured to have different shapes from each other. As an example, a case where the plurality of partial reading regions have the same size and the same shape as each other will be described. As an example, a case where the plurality of partial reading regions are seven partial reading regions of a partial reading region RA, a partial reading region RB, a partial reading region RC, a partial reading region RD, a partial reading region RE, a partial reading region RF, and a partial reading region RG will be described.

If the image information reading region PA is virtually divided into seven partial reading regions, the target image information read from the reading target in the image information reading region PA can be divided into image information read in each of the seven partial reading regions.

Herein, the streak detection unit 301 detects a position of the streak image information in the main scanning direction based on the acquired target image information. The method of detecting the position of such streak image information may be a known method or a method to be developed in the future. The streak detection unit 301 specifies whether the detected streak image information is read in any of the seven partial reading regions allocated to the image information reading region PA based on the detected position of the streak image information. At this time, the streak detection unit 301 divides the information into pieces of the image information read in each of the seven partial reading regions allocated to the image information reading region PA. This corresponds to dividing the region on the image indicated by the target image information acquired by the streak detection unit 301 into seven partial regions. For the convenience of description, each partial region in which the region on the image is divided into the seven partial regions is referred to as a partial image region. The partial image region RAR illustrated in FIG. 4 illustrates a region of the image indicated by the image information read in the partial reading region RA of the image information reading region PA among the regions on the image indicated by the target image information acquired by the streak detection unit 301. The partial image region RBR illustrated in FIG. 4 illustrates a region of the image indicated by the image information read in the partial reading region RB of the image information reading region PA among the regions on the image indicated by the target image information acquired by the streak detection unit 301. The partial image region RCR illustrated in FIG. 4 illustrates a region of the image indicated by the image information read in the partial reading region RC of the image information reading region PA among the regions on the image indicated by the target image information acquired by the streak detection unit 301. The partial image region RDR illustrated in FIG. 4 illustrates a region of the image indicated by the image information read in the partial reading region RD of the image information reading region PA among the regions on the image indicated by the target image information acquired by the streak detection unit 301. The partial image region RER illustrated in FIG. 4 illustrates a region of the image indicated by the image information read in the partial reading region RE of the image information reading region PA among the regions on the image indicated by the target image information acquired by the streak detection unit 301. The partial image region RFR illustrated in FIG. 4 illustrates a region of the image indicated by the image information read in the partial reading region RF of the image information reading region PA among the regions on the image indicated by the target image information acquired by the streak detection unit 301. The partial image region RGR illustrated in FIG. 4 illustrates a region of the image indicated by the image information read in the partial reading region RG of the image information reading region PA among the regions on the image indicated by the target image information acquired by the streak detection unit 301.

The streak detection unit 301 divides the region on the image indicated by the target image information acquired by the streak detection unit 301 into seven partial image regions and, then, specifies whether the position of the detected streak image information is included in any of the seven partial image regions. Each time the streak detection unit 301 acquires the target image information from the image reading unit 150, the streak detection unit 301 repeatedly performs each of the detection of the position of the streak image information and the specification of the partial image region in which the position of the detected streak image information in the seven partial image regions is included. In other words, each time the target image information is read by the image reading unit 150, the streak detection unit 301 repeatedly performs each of the detection and the specification. Accordingly, the streak detection unit 301 can allow the count unit 302 to count the number of times of streak detection in the partial image region (that is, the number of times of specification that the streak image information is included) for each of the seven partial image regions as the number of times of streak appearance in the partial image region. If the streak detection unit 301 specifies that the streak image information is included in a certain partial image region, the streak detection unit 301 outputs the streak detection information indicating that the streak is detected in association with partial image region identification information for identifying the partial image region to the count unit 302. The partial image region identification information may be any information as long as the partial image region identification information can identify the partial image region and is, for example, an ID (Identifier) for identifying the partial image region. For example, if the streak detection unit 301 detects a streak in the partial image region RAR, the streak detection unit 301 outputs the streak detection information in association with the partial image region identification information for identifying the partial image region RAR to the count unit 302.

(Data Flow after Reading Target Image Information in Image Reading Device)

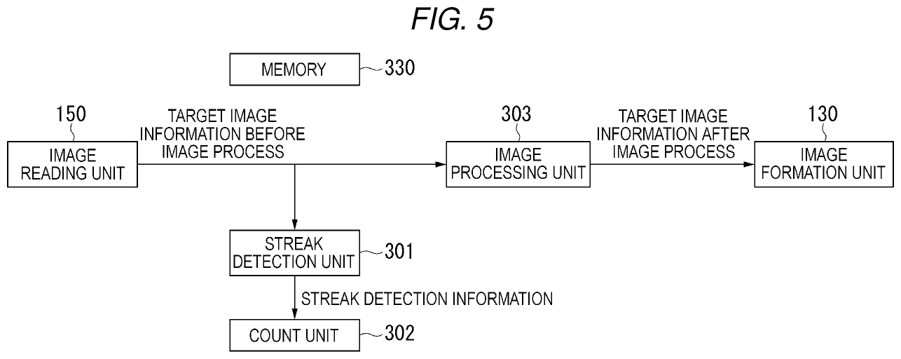

FIG. 5 is a diagram illustrating an example of a data flow after reading the target image information in the image reading device 100.

In the image reading device 100, the image reading unit 150 outputs the read target image information to each of the streak detection unit 301 and the image processing unit 303. After that, in the image reading device 100, a first process by the streak detection unit 301 and the count unit 302 and a second process by the image processing unit 303 are performed in parallel.

The streak detection unit 301 performs the following process as the first process. The streak detection unit 301 detects a streak in each of the seven partial image regions of the target image information acquired from the image reading unit 150. If a streak is not detected in a certain partial image region among the seven partial image regions, the streak detection unit 301 maintains the value of the number of times of streak appearance in the partial image region without a change. On the other hand, if a streak is detected in a certain partial image region among the seven partial image regions, the streak detection unit 301 generates streak detection information associated with the partial image region identification information for identifying the partial image region. After generating the streak detection information for the partial image region, the streak detection unit 301 outputs the generated streak detection information to the count unit 302. If the streak detection information is acquired, the count unit 302 increments the value of the number of times of streak appearance in the partial image region identified by the partial image region identification information associated with the acquired streak detection information by 1. The streak detection unit 301 and the count unit 302 perform the above-described process as the first process.

As the second process, the image processing unit 303 performs the conversion of synchronous system and asynchronous system of the target image information acquired from the image reading unit 150, various image processes for forming an image of the target image information on the print medium, and the like. In the example illustrated in FIG. 4, the target image information after the image process performed in the second process is output from the image processing unit 303 to the image formation unit 130.

As described above, since the image reading device 100 performs the first process and the second process in parallel, the time required for reading the target image information from the reading target can be prevented from unnecessarily increasing, and thus, efficient operations can be performed.

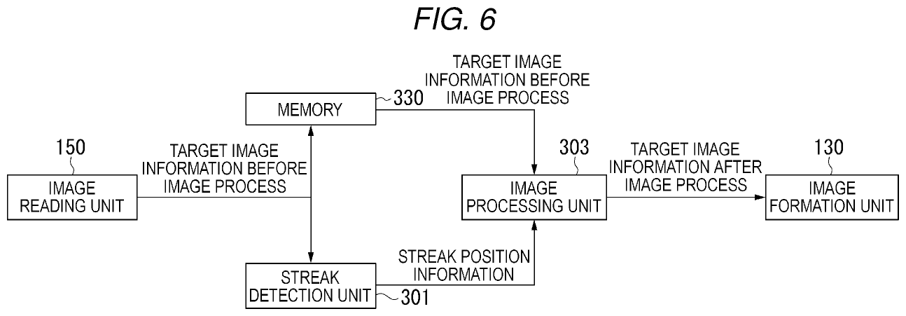

On the other hand, FIG. 6 is a diagram illustrating an example of a data flow after reading the target image information if the image reading device 100 performs the same operation as the image reading device in the related art. In this case, in the image reading device 100, the image reading unit 150 temporarily stores the read target image information in the memory 330 and outputs the read target image information to the streak detection unit 301. After that, in the image reading device 100, after the third process by the streak detection unit 301 is performed, the fourth process by the image processing unit 303 is performed.

The streak detection unit 301 performs the following process as the third process. The streak detection unit 301 detects a streak in a region on the image indicated by the target image information acquired from the image reading unit 150. After detecting the streak in the region, the streak detection unit 301 does not perform any process if the streak is not detected. On the other hand, after detecting the streak in the region, if the streak is detected, the streak detection unit 301 detects the position of the streak in the region and generates the streak position information indicating the detected position. After generating the streak position information, the streak detection unit 301 outputs the generated streak position information to the image processing unit 303. The streak detection unit 301 performs the above-described process as the third process.

The image processing unit 303 performs the following process as the fourth process. The image processing unit 303 reads the target image information temporarily stored in the memory 330. The image processing unit 303 performs a process of removing the streak image information from the target image information acquired from the image reading unit 150 based on the read target image information and the streak position information acquired from the streak detection unit 301. After that, the image processing unit 303 performs the conversion of synchronous system and asynchronous system of the target image information after the streak image information is removed, various image processes of forming the image indicated by the target image information on the print medium, and the like. The image processing unit 303 performs the above-described process as the fourth process. In the example illustrated in FIG. 6, the target image information after the image process is performed in the fourth process is output from the image processing unit 303 to the image formation unit 130.

As described above, if the image reading device 100 performs the same operation as the image reading device in the related art, since the image reading device 100 performs the third process and the fourth process in order, the time required for reading the target image information from the reading target increases. As a result, in this case, the image reading device 100 may not be able to perform efficient operations. That is, since the image reading device 100 can perform the first process and the second process in parallel, the image reading device 100 can prevent the time required for reading the target image information from the reading target from increasing, and thus, can perform efficient operations.

(Image Information Reading Process Performed by Control Unit)

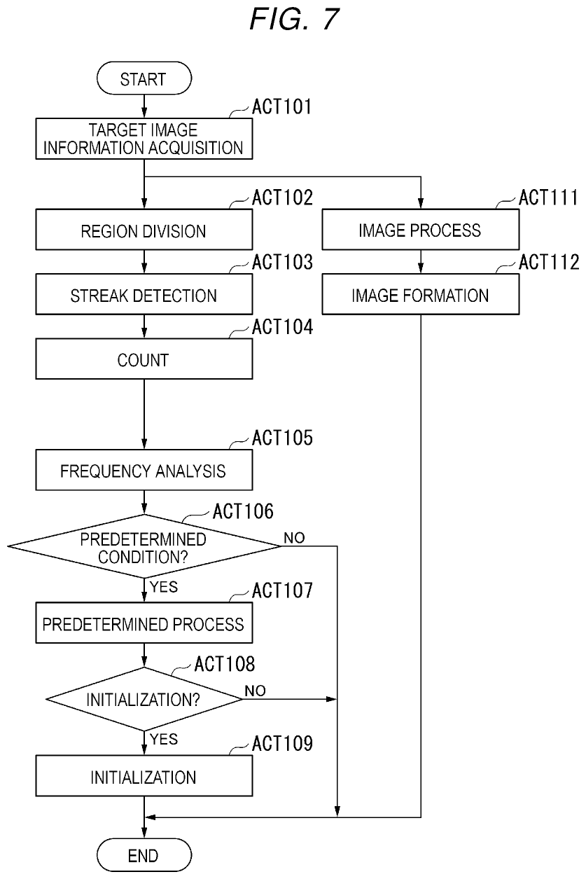

The image information reading process performed by the control unit 300 will be described with reference to FIG. 7. The image information reading process is a process of reading the target image information of the reading target by the image reading unit 150 among the processes performed by the control unit 300. As an example, the image information reading process when performing the process of forming the image indicated by the image information of the reading target on the print medium will be described. FIG. 7 is a diagram illustrating an example of a flow of the image information reading process when performing the process of forming the image indicated by the image information of the reading target on the print medium. As an example, a case where the image reading device 100 accepts the operation of causing the image reading device 100 to start the image information reading process at the timing before the process of ACT 101 illustrated in FIG. 7 is performed will be described. As an example, a case where the operation mode of the image reading unit 150 is a scan reading mode at the timing will be described. As an example, a case where one-sheet reading target is loaded on the tray 151 at the timing will be described. As an example, a case where the number-of-times-of-streak-appearance information for each of the seven partial image regions from the partial image region RAR to the partial image region RGR is stored in the storage unit 320 in advance will be described. The number-of-times-of-streak-appearance information of a certain partial image region among the seven partial image regions is information indicating the number of times of streak appearance detected in the partial image region. For example, the number-of-times-of-streak-appearance information of the partial image region RAR is information indicating the number of times of streak appearance detected in the partial image region RAR.

The control unit 300 allows the image reading unit 150 to read the image information of the one-sheet reading target loaded on the tray 151 as the target image information (ACT 101). Accordingly, in the scan reading mode, the image reading unit 150 allows the conveying unit 153 to convey one-sheet reading target loaded on the tray 151 and reads the image information of the reading target as the target image information. After reading the target image information, the image reading unit 150 outputs the read target image information to each of the streak detection unit 301 and the image processing unit 303 of the control unit 300.

After the process of ACT 101 is performed, in the image reading device 100, the processes from ACT 102 to ACT 109 and the processes from ACT 111 and ACT 112 are performed in parallel.

The flow of processes from ACT102 to ACT109 will be described.

After the process of ACT 101 is performed, the streak detection unit 301 sets the region on the image indicated by the target image information as the target region and divides the target region into seven partial image regions from the partial image region RAR to the partial image region RGR (ACT102). The method of dividing the target region into seven partial image regions may be a known method or may be a method to be developed in the future. In FIG. 7, the process of ACT 102 is illustrated by “regional division”.

Next, the streak detection unit 301 detects streaks for each of the seven partial image regions divided from the target region (ACT103).

Next, the streak detection unit 301 counts the number of times of streak appearance in each of the seven partial image regions divided from the target region based on the streak detection result obtained by the process of ACT 103 (ACT104). For example, if the streak detection unit 301 detects a streak in the partial image region RAR in ACT 103, the streak detection unit 301 increments the value of the number of times of streak appearance indicated by the number-of-times-of-streak-appearance information of the partial image region RAR stored in advance in the storage unit 320 by 1. On the other hand, for example, if the streak detection unit 301 does not detect a streak in the partial image region RAR in ACT 103, the streak detection unit 301 maintains the value of the number of times of streak appearance indicated by the number-of-times-of-streak-appearance information of the partial image region RAR stored in advance in the storage unit 320 without a change. In this manner, the streak detection unit 301 counts the number of times of streak appearance in the partial image region RAR. In ACT 104, the streak detection unit 301 counts the number of times of streak appearance in each of the partial image regions from the partial image region RAR to the partial image region RGR.

Next, the determination unit 304 performs a frequency analysis for calculating the streak appearance frequency based on the number of times of streak appearance in the partial image region for each of the seven partial image regions (ACT 105). The streak appearance frequency may be the number of times of streak appearance itself or may be another value calculated based on the number of times of streak appearance. The other value is, for example, a value obtained by dividing the number of times of streak appearance by the number of times of reading of the target image information by the image reading unit 150 from the timing when the number of times of streak appearance was initialized to the current timing, but not limited thereto. With respect to the streak appearance frequency in a certain partial image region, the higher the value, the more times of detection of the streaks in the partial image region. As an example, a case where the streak appearance frequency is the number of times of streak appearance itself will be described.

Next, the determination unit 304 determines whether or not a predetermined condition is satisfied (ACT 106). In FIG. 7, the process of ACT 106 is indicated by “predetermined condition?”. The predetermined condition includes one or more conditions. If at least one of the one or more conditions included in the predetermined condition is satisfied, the determination unit 304 determines that the predetermined condition is satisfied. On the other hand, if all of the one or more conditions included in the predetermined condition are not satisfied, the determination unit 304 determines that the predetermined condition is not satisfied.

The predetermined condition may include, for example, a condition that a streak appearance frequency equal to or more than a predetermined threshold value Th is included in the streak appearance frequency for each of the seven partial image regions. The threshold value Th is, for example, 10, but not limited thereto. This condition is a condition for specifying occurrence of adhesion of the contaminants or the like to some of the partial reading regions among the above-mentioned seven partial reading regions. This is because, if the contaminants adhere to a certain partial reading region, the streak is detected in the partial image region associated with the partial reading region.

The predetermined condition may include, for example, a condition that all of the streak appearance frequencies for each of the seven partial image regions are equal to or more than a threshold value ThL lower than the threshold value Th. The threshold value ThL is, for example, 5, but not limited thereto. This condition is a condition used for specifying occurrence of adhesion of the contaminants or the like to all of the image information reading regions PA. This is because, if the contaminants adhere to all of the seven partial reading regions, the streak is detected in all of the seven partial image regions.

The predetermined condition may be configured to include other conditions instead of one or both of the two conditions or in addition to one or both of the two conditions. However, each of the one or more conditions included in the predetermined condition is a condition for specifying occurrence of adhesion of the contaminants or the like to some or all of the image information reading regions PA.

As an example, a case where only the condition that the streak appearance frequency equal to or more than the threshold value Th is included in the streak appearance frequency for each of the seven partial image regions is included in the predetermined condition will be described. In this case, in ACT 106, the determination unit 304 determines whether or not the streak appearance frequency equal to or more than the threshold value Th is included in the streak appearance frequency for each of the seven partial image regions.

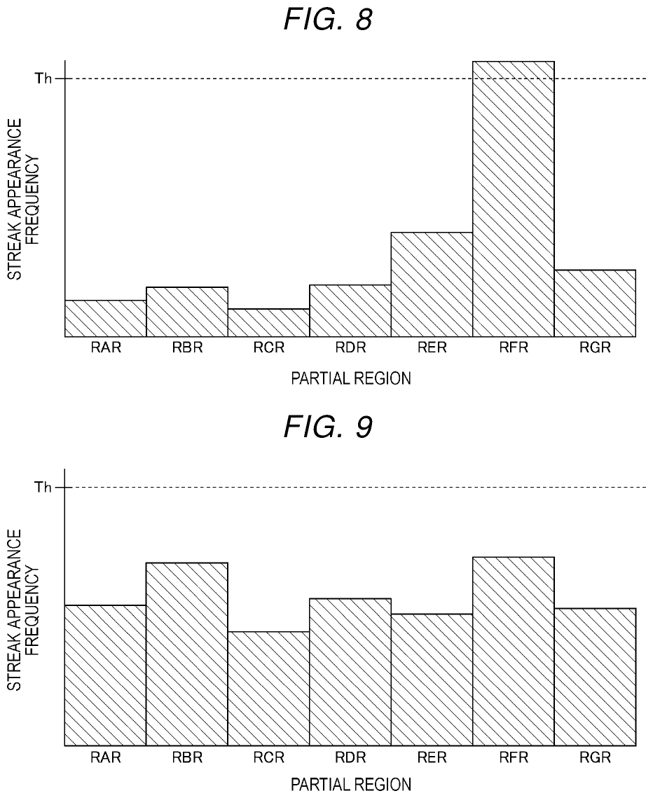

FIG. 8 is a diagram illustrating an example of a histogram illustrating the streak appearance frequency for each of the seven partial image regions. In the example illustrated in FIG. 8, the streak appearance frequency for the partial image region RFR among the seven partial image regions is equal to or more than the threshold value Th. In such a case, in ACT 106, the determination unit 304 determines that the streak appearance frequency equal to or more than the threshold value Th is included in the streak appearance frequency for each of the seven partial image regions. In this case, there is a high possibility that the contaminants adhere to the partial reading region RF associated with the partial image region RFR. Therefore, in this case, the image reading device 100 can allow the user to remove the cause of detection of the streaks in the partial image region RFR by prompting the user to perform maintenance of the partial reading region RF.

On the other hand, FIG. 9 is a diagram illustrating another example of the histogram illustrating the streak appearance frequency for each of the seven partial image regions. In the example illustrated in FIG. 9, the streak appearance frequency for all of the seven partial image regions is less than the threshold value Th. In such a case, in ACT 106, the determination unit 304 determines that the streak appearance frequency equal to or more than the threshold value Th is not included in the streak appearance frequency for each of the seven partial image regions. In this case, there is a high possibility that the adhesion of the contaminants and the peeling of the contaminants are repeated in each partial reading region, and thus, the streak is sporadically detected in each partial image region. Therefore, in this case, the image reading device 100 may not prompt the user to perform maintenance of the image information reading regions PA.

If the control unit 300 determines that the predetermined condition is not satisfied (NO in ACT106), the process of the flowchart illustrated in FIG. 7 is ended.

On the other hand, if the determination unit 304 determines that the predetermined condition is satisfied (YES in ACT106), the processing unit 305 performs a predetermined process based on the streak appearance frequency (ACT107). In FIG. 7, the process of ACT 107 is indicated by a “predetermined process”. The predetermined process is a process based on the streak appearance frequency. Since the streak appearance frequency is a value based on the number of times of streak appearance, the predetermined process may be paraphrased as a process based on the number of times of streak appearance. In other words, the predetermined process is a process related to suppression of streak occurrence.

More specifically, in ACT 107, the processing unit 305 performs the following process as a predetermined process. The processing unit 305 specifies a partial image region having a streak appearance frequency equal to or more than the threshold value Th among the seven partial image regions. For example, if the partial image regions in which the streak appearance frequency is equal to or more than the threshold value Th are two partial image regions of the partial image region RAR and the partial image region RGR, the processing unit 305 specifies the two partial image regions as a target partial image region. For example, if the partial image regions in which the streak appearance frequency is equal to or more than the threshold value Th are all of the seven partial image regions from the partial image region RAR to the partial image region RGR, the processing unit 305 specifies the seven partial image regions as the target partial image region. After specifying one or more target partial image regions, the processing unit 305 generates a maintenance promotion image for promoting maintenance of the partial reading region associated with each of the specified one or more target partial image regions.

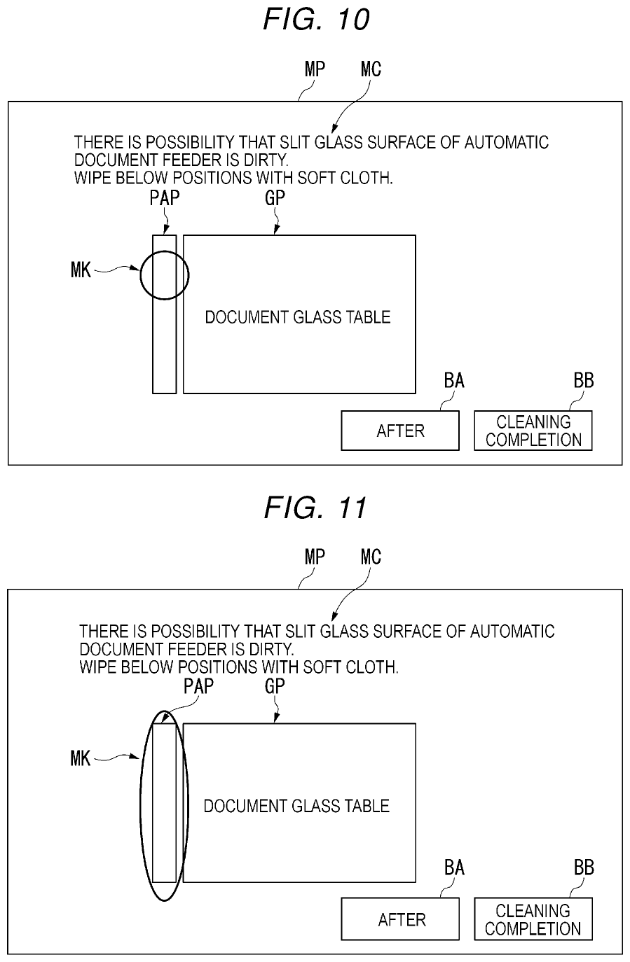

For example, if the target partial image region is the partial image region RFR, the processing unit 305 generates an image as illustrated in FIG. 10 as a maintenance promotion image for the partial reading region RF associated with the partial image region RFR. FIG. 10 is a diagram illustrating an example of the maintenance promotion image for the partial reading region RF.

An image MP illustrated in FIG. 10 is an example of the maintenance promotion image for the partial reading region RF. The image MP includes, for example, a sentence MC, an image GP, a marker MK, a button BA, and a button BB. In addition to these, the image MP may be configured to include other sentences, other images, and the like.

The sentence MC is a sentence that prompts maintenance. In the example illustrated in FIG. 10, the sentence MC is a sentence “The slit glass surface of the automatic document feeder may be dirty. Please wipe the below positions with a soft cloth”. However, the sentence MC is not limited thereto as long as the sentence MC is a sentence that can promote maintenance.

The image GP is an image illustrating the upper surface of the glass table 152. An image PAP is included in the image GP. The image PAP is an image indicating the image information reading region PA in the region on the glass table 152.

The marker MK is an image indicating a region corresponding to the partial reading region associated with the target partial image region in the region on the image PAP. In the example illustrated in FIG. 10, since the target partial image region is the partial image region RFR, the marker MK indicates a region corresponding to the partial reading region RF among the regions on the image PAP. In this example, the marker MK is drawn as a circle surrounding the region. Instead of such a circle, the marker MK may be another figure such as an arrow indicating the region and a rectangle indicating the region. The marker MK superimposed on the image PAP allows the user to visually and easily specify a portion of the image information reading region PA to perform maintenance prompted by the sentence MC.

The button BA is a button that allows the image reading device 100 to specify that the maintenance promoted by the image MP is not performed. If the selection operation (tap, click, or the like) is performed on the button BA, the image reading device 100 specifies that the user does not perform the maintenance prompted by the image MP.

The button BB is a button that allows the image reading device 100 to specify that the maintenance promoted by the image MP is performed. If a selection operation (tap, click, or the like) is performed on the button BB, the image reading device 100 specifies that the maintenance prompted by the image MP is performed by the user. After that, the image reading device 100 initializes the number of times of streak appearance in each of the seven partial image regions. For this reason, the button BB may be a button that initializes the number of times of streak appearance in each of the seven partial image regions.

The image MP may have a configuration in which the button BA is not included. In this case, the image reading device 100 includes a hardware button or a software button having the function of the button BA.

The image MP may have a configuration in which the button BB is not included. In this case, the image reading device 100 includes a hardware button or a software button having the function of the button BB.

On the other hand, for example, if the target partial image regions are all of the seven partial image regions from the partial image region RAR to the partial image region RGR, the processing unit 305 generates an image as illustrated in FIG. 11 as a maintenance promotion image for all of the image information reading regions PA. FIG. 11 is a diagram illustrating an example of the maintenance promotion image for all of the image information reading regions PA. A difference between the image MP illustrated in FIG. 11 and the image MP illustrated in FIG. 10 is only the region indicated by the marker MK. The marker MK illustrated in FIG. 11 is drawn as a circle surrounding the entire image PAP indicating the image information reading regions PA. This is because, as described above, in this example, the target partial image regions are all of the seven partial image regions from the partial image region RAR to the partial image region RGR.

After generating the maintenance promotion image such as the image MP, the processing unit 305 displays the generated maintenance promotion image on the display 110. The processing unit 305 performs the above-described process as a predetermined process.

The predetermined process may be any process as long as the predetermined process is a process based on the streak appearance frequency instead of the process of generating and displaying the maintenance promotion image as described above. For example, the predetermined process may be a process of outputting a voice prompting the maintenance of the partial reading region associated with each of the one or more target partial image regions specified by the processing unit 305. In this case, the image reading device 100 includes a speaker. For example, the predetermined process may be a process of blinking the light promoting the maintenance. In this case, the image reading device 100 may have a configuration of including an LED or the like that blinks the light or may have a configuration of blinking the light on the display 110. For example, the predetermined process may be a process of generating vibration of a pattern promoting the maintenance. In this case, the image reading device 100 includes an oscillator that causes the vibration. For example, the predetermined process may further have a configuration of including a process of enabling the image processing unit 303 to execute the image process of removing the streak image information from the target image information. In this case, the image processing unit 303 has a function of executing the image process, and if the target image information is acquired, the image processing unit 303 removes the streak image information from the target image information by the image process. In order to remove such streak image information, in this case, the image processing unit 303 acquires the above-mentioned streak position information from, for example, the streak detection unit 301. In the image reading device 100, the execution of the image process by the image processing unit 303 may be realized by any process flow. However, even if the image process is executed, the image reading device 100 does not initialize the number of times of streak appearance. This is because, if the number of times of streak appearance is initialized by executing the image process, the maintenance promotion image is not displayed even though the cause of the streak image information being included in the target image information is not removed. The predetermined process may be, for example, a process of notifying a request for maintenance to the maintenance company of the image reading device 100. The process may be a process of transmitting the notification by an e-mail, a social networking service (SNS), or the like, may be a process of requesting delivery of the notification by a direct mail or the like, may be a process of displaying a sentence, an image, or the like prompting the user to display the notification on the display 110, or may be another process of performing the notification. If the image reading device 100 includes a removing unit for removing the contaminants and the like on the image information reading region PA under the control of the control unit 300, the predetermined process may be, for example, a process of allowing the removing unit to remove the contaminants or the like on the image information reading region PA. The removing unit is configured with, for example, a motor, a plurality of gears driven by the motor, a removing member such as a brush for removing the contaminants and the like on the image information reading region PA by driving the plurality of gears or the like.

After the process of ACT 107 is performed, the determination unit 304 determines whether or not to initialize the number of times of streak appearance in each of the seven partial image regions (ACT 108). For example, if the determination unit 304 accepts the selection operation for the button BB included in the image MP, the determination unit 304 determines that the initialization is performed. On the other hand, for example, if the determination unit 304 accepts the selection operation for the button BA included in the image MP, the determination unit 304 determines that the initialization is not performed. The determination unit 304 may be configured to determine whether or not to perform the initialization by another method.

If the determination unit 304 determines that the number of times of streak appearance in each of the seven partial image regions is not initialized (NO in ACT108), the control unit 300 allows the process of the flowchart illustrated in FIG. 7 to be ended.

On the other hand, if the determination unit 304 determines that the number of times of streak appearance in each of the seven partial image regions is initialized (YES in ACT108), the initialization unit 306 performs the initialization (ACT109). After the process of ACT 109 is performed, the control unit 300 allows the process of the flowchart illustrated in FIG. 7 to be ended.

The flow of processes from ACT111 and ACT112 will be described.

After the process of ACT 101 is performed, the image processing unit 303 performs the conversion of synchronous system and asynchronous system of the target image information, various image processes of forming an image of the target image information on the print medium, and the like (ACT111). After that, the image processing unit 303 outputs the target image information after performing the image process to the image formation unit 130.

Next, the image formation unit 130 forms the image indicated by the target image information acquired from the image processing unit 303 in ACT 111 on the print medium (ACT 112). After the process of ACT 112 is performed, the control unit 300 allows the process of the flowchart illustrated in FIG. 7 to be ended.

As described above, the image reading device 100 detects whether or not the streak image information is included in the target image information each time the target image information is read by the image reading unit 150 and performs the predetermined process based on the streak appearance frequency included in the target image information in which the streak image information is included. Accordingly, the image reading device 100 can prevent the time required for reading the target image information from the reading target from unnecessarily increasing, and thus, can perform efficient operations.

The process of the flowchart described above is the process if the operation mode of the image reading unit 150 is the scan reading mode. If the operation mode of the image reading unit 150 is the manual reading mode, the streak detection unit 301 performs the following process as the process of ACT 101 instead of the process of ACT 101 described above. In other words, the streak detection unit 301 performs different processes in each operation mode of the image reading unit 150. For this reason, preferably, the image reading device 100 counts the number of times of streak appearance independently in each of the case where the operation mode of the image reading unit 150 is the scan reading mode and the case where the operation mode of the image reading unit 150 is the manual reading mode.

If the operation mode of the image reading unit 150 is the manual reading mode, the processing unit 305 allows the image reading unit 150 to read the image information of one-sheet reading target mounted on the glass table 152 in ACT 101 as the target image information.

If the operation mode of the image reading unit 150 is the manual reading mode, the processing unit 305 performs the following process as the process of ACT 107 instead of the process of ACT 107 described above.

If the operation mode of the image reading unit 150 is the manual reading mode, in ACT 107, the processing unit 305 performs a process of notifying a request for the maintenance to the maintenance company of the image reading device 100 as a predetermined process. This is because there is a high possibility that the reason why the streak image information is included in the target image information in this case is the adhesion of contaminants or the like to the positions that is hard for the user to remove. The positions are, for example, positions on the surface of the reflecting member included in the first optical system 154, the second optical system 155, or the like, but not limited thereto. The predetermined process in this case may include a process of informing the user that a request for maintenance is notified to the maintenance company of the image reading device 100. The process is, for example, a process of displaying an image informing the user that the notification is made on the display 110, a process of outputting a voice informing the user that the notification is made, or a process of blinking the light informing the user that the notification is made, but not limited thereto. If the image reading device 100 is provided with a removing unit for removing the contaminants or the like on the surface of the reflecting member under the control of the control unit 300, the predetermined process in this case may be, for example, a process of allowing the removing unit to remove the contaminants or the like on the image information reading region PA. The removing unit is configured with, for example, a motor, a plurality of gears driven by the motor, a removing member such as a brush that removes the contaminants and the like on the surface of the reflecting member by driving the plurality of gears, and the like. As described above, if the operation mode of the image reading unit 150 is the manual reading mode, the processing unit 305 performs the above-described process as the process of ACT 107.

(Initialization Process Performed by Control Unit)

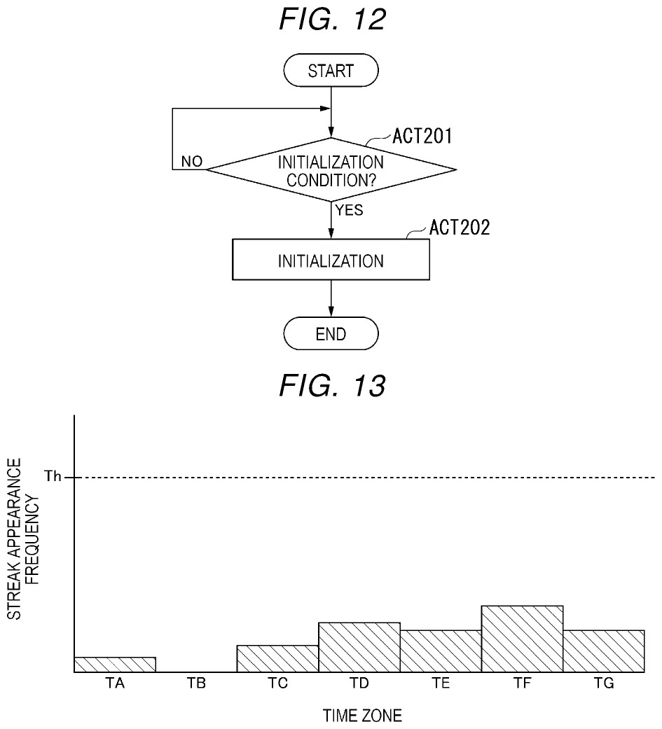

The initialization process performed by the control unit 300 will be described with reference to FIG. 12. The initialization process is a process of initializing the value of the number of times of streak appearance indicated by all the number-of-times-of-streak-appearance information stored in the storage unit 320 to 0 among the processes performed by the control unit 300. FIG. 12 is a diagram illustrating an example of the flow of the initialization process performed by the control unit 300. The control unit 300 repeatedly performs the process of the flowchart illustrated in FIG. 12, for example, after the image reading device 100 is powered on by the time when the image reading device 100 is powered off.

The initialization unit 306 waits until a predetermined initialization condition is satisfied (ACT201).

The initialization condition includes one or more conditions. If at least one of the one or more conditions included in the initialization condition is satisfied, the initialization unit 306 determines that the initialization condition is satisfied. On the other hand, if all of the one or more conditions included in the initialization condition are not satisfied, the initialization unit 306 determines that the initialization condition is not satisfied.

The initialization condition may include, for example, a condition that the current time is a predetermined time. The predetermined time is, for example, midnight, but not limited thereto. This condition is a condition for periodically initializing the value of the number of times of streak appearance indicated by all the number-of-times-of-streak-appearance information stored in the storage unit 320 to 0. If this condition is included in the initialization condition, the initialization unit 306 periodically initializes the value of the number of times of streak appearance indicated by all the number-of-times-of-streak-appearance information stored in the storage unit 320 to 0.

The initialization condition is, for example, that a predetermined initialization operation is accepted. The initialization operation is, for example, an operation in which the initialization unit 306 initializes the value of the number of times of streak appearance indicated by all the number-of-times-of-streak-appearance information stored in the storage unit 320 to 0. However, the initialization operation is an operation different from the operation of selecting the button BB included in the maintenance promotion image illustrated in FIG. 10 and FIG. 11. If this condition is included in the initialization condition, the image reading device 100 includes a hardware key or a software key for accepting the initialization operation, such as a button for accepting the initialization operation in addition to the button BB.

### Modified Example of Embodiment

Modified Example of the embodiment will be described. In Modified Example of the embodiment, the image reading device 100 counts the number of times of streak appearance in each of N predetermined time zones for each of the seven partial image regions. N may be any integer as long as N is an integer of 2 or more. The individual time zones included in the N time zones are any of N time periods when the 24 hours from midnight are divided into the N time periods. The method of dividing into the N time zones for 24 hours from midnight may be any method. As an example, a case where N is 7 will be described. For the convenience of description, each of the seven time zones will be referred to as a time zone TA, a time zone TB, a time zone TC, a time zone TD, a time zone TE, a time zone TF, and a time zone TG in order from midnight.

Also in Modified Example of the embodiment, the image information reading process will be described by exemplifying the image information reading process if the process of forming the image indicated by the image information of the reading target on the print medium is performed. In this case, the control unit 300 according to Modified Example of the embodiment performs the image information reading process based on the flowchart illustrated in FIG. 7. However, in Modified Example of the embodiment, the processes from ACT 103 to ACT 107 are different from the processes described in the embodiment.

The processes from ACT 103 to ACT 107 according to Modified Example of the embodiment will be described. As an example, a case where the number-of-times-of-streak-appearance information indicating the number of times of streak appearance of each of the seven time zones is stored in the storage unit 320 for each of the seven partial image regions will be described.

The control unit 300 according to Modified Example of the embodiment performs the following processes as the processes from ACT 103 to ACT 107.

In ACT 103, the streak detection unit 301 performs a process of specifying the current time in addition to the process of ACT 103 described in the embodiment. For the convenience of description, the current time specified in ACT 103 will be referred to as a target current time.

In ACT 104, the streak detection unit 301 counts the number of times of streak appearance in the time zone including the target current time among the seven time zones for each of the seven partial image regions based on the streak detection result by the process of ACT 103. For example, if the streak is detected in the partial image region RAR in ACT 103, the streak detection unit 301 increments the value of the number of times of streak appearance indicated by the number-of-times-of-streak-appearance information in the time zone including the target current time in the number-of-times-of-streak-appearance information of the partial image region RAR stored in advance in the storage unit 320 by 1. On the other hand, for example, if a streak is not detected in the partial image region RAR in ACT 103, the streak detection unit 301 maintains the value of the number of times of streak appearance indicated by the number-of-times-of-streak-appearance information in the time zone including the target current time in the number-of-times-of-streak-appearance information of the partial image region RAR stored in advance in the storage unit 320 without a change. In this manner, the streak detection unit 301 counts the number of times of streak appearance in the time zone including the target current time among the seven time zones, which is the number of times of streak appearance in the partial image region RAR. In ACT 104, the streak detection unit 301 counts the number of times of streak appearance in each of the partial regions from the partial region RAR to the partial region RGR.

In ACT 105, the determination unit 304 performs a frequency analysis for calculating the streak appearance frequency based on the number of times of streak appearance in each of the seven time zones for each of the seven partial image regions. In Modified Example of the embodiment, the case where the streak appearance frequency is the number of times of streak appearance itself will also be described as an example.

In ACT 106, the determination unit 304 determines whether or not the predetermined condition is satisfied. The predetermined condition according to Modified Example of the embodiment also includes one or more conditions. If at least one among the one or more conditions included in the predetermined condition is satisfied, the determination unit 304 determines that the predetermined condition is satisfied. On the other hand, if all of one or more conditions included in the predetermined condition are not satisfied, the determination unit 304 determines that the predetermined condition is not satisfied.

For the convenience of description, among the seven time zones, the time zone including the target current time will be referred to as a target time zone.

As an example, a case where the three conditions of the first condition, the second condition, and the third condition are included in the predetermined condition according to Modified Example of the embodiment will be described.

The first condition is, for example, that the streak appearance frequency equal to or more than the predetermined threshold value Th is included in the streak appearance frequency in the target time zone for each of the seven partial image regions. The first condition is a condition for specifying occurrence of adhesion of the contaminants or the like to some of the partial reading regions among the seven partial reading regions in the target time zone.

The second condition is, for example, that all of the streak appearance frequencies in the target time zone for each of the seven partial image regions are equal to or more than the threshold value ThL that is lower than the threshold value Th. The second condition is a condition used to specify occurrence of adhesion of the contaminants or the like to all of the image information reading regions PA in the target time zone.

The third condition is that a time zone is adjacent to the time zone in which the selection operation of the button BB on the recently displayed maintenance promotion image is performed and the streak appearance frequency for the partial image region associated with the partial reading region indicated by the marker MK on the maintenance promotion image is equal to or more than the threshold value Th. The third condition is a condition used for specifying the existence of the partial reading region in which the streak is detected even after the maintenance is performed.

FIG. 13 is a diagram illustrating an example of a histogram illustrating the streak appearance frequency in the partial image region RAR in each of the seven time zones. In the example illustrated in FIG. 13, the streak appearance frequency in the partial image region RFR is less than the threshold value Th for all of the seven time zones. In such a case, in ACT 106, the determination unit 304 determines that the predetermined condition is not satisfied.

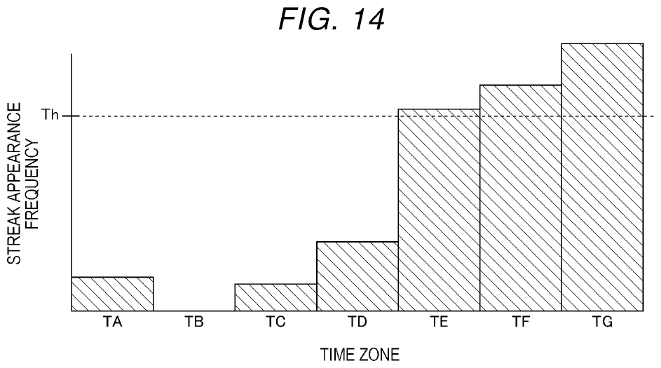

On the other hand, FIG. 14 is a diagram illustrating another example of the histogram illustrating the streak appearance frequency in the partial image region RER in each of the seven time zones. In the example illustrated in FIG. 14, the streak appearance frequency in the partial image region RER rapidly increases in the time zone TE and exceeds the threshold value Th. Further, even in the time zone TF and the time zone TG, which are the time zones after the time zone TE, the streak appearance frequency of the partial image region RER exceeds the threshold value Th. For example, if the maintenance of the partial reading region RE associated with the partial image region RER is performed in the time zone TE, even in the time zone TF adjacent to the time zone TE, the streak appearance frequency in the partial image region RER exceeds the threshold value Th even though the maintenance is performed. In such a case, there is a high possibility that the reason why the streak image information is included in the target image information is the adhesion of contaminants or the like to a position that is hard for the user to remove. The above-mentioned third condition is a condition for specifying that the state of the image reading device 100 is such a state.

In ACT 107, the processing unit 305 determines which of the three conditions included in the predetermined condition is satisfied. For example, if the first condition is satisfied in ACT 106, the processing unit 305 performs a process of displaying the maintenance promotion image as illustrated in FIG. 10 on the display 110 as a predetermined process. For example, if the second condition is satisfied in ACT 106, the processing unit 305 performs a process of displaying the maintenance promotion image as illustrated in FIG. 11 on the display 110 as a predetermined process. For example, if the third condition is satisfied in ACT 106, the processing unit 305 performs a process of notifying a request for maintenance to the maintenance company of the image reading device 100 as a predetermined process. This is because there is a high possibility that the reason why the streak image information is included in the target image information in this case is the adhesion of contaminants or the like to the position that is hard for the user to remove.

As described above, if the number of times of streak appearance in each of N predetermined time zones for each of the seven partial image regions is counted, the image reading device 100 can prevent the time required for reading the target image information from the reading target from unnecessarily increasing, and as a result, can perform efficient operations.

The image information reading region PA described above may be configured not to be divided into a plurality of partial regions.

The operation mode included in the image reading unit 150 described above may be configured to include only one of the scan reading mode and the manual reading mode. In this case, among the members included in the image reading unit 150, the members used only in the operation mode not provided by the image reading unit 150 may be configured not to be provided in the image reading unit 150. For example, if the operation mode of the image reading unit 150 does not include the scan reading mode, the image reading unit 150 may be configured not to include the tray 151 or the like. For example, if the operation mode of the image reading unit 150 does not include the manual reading mode, the image reading unit 150 may be configured not to include the carriage 157, the motor 158, or the like.

As described above, the image reading device (image reading device 100 in the example described above) includes an image reading unit (image reading unit 150 in the example described above) and a control unit (control unit 300 in the example described above). The image reading unit reads the image information of the reading target (in the example described above, the reading target TGP) as the target image information. The control unit controls the image reading unit. Each time the target image information is read by the image reading unit, the control unit detects whether or not the image information (in the example described above, the streak image information) of the streak not included in the reading target is included in the target image information and performs the process related to suppression of streak occurrence (predetermined process in the example described above) based on the number of times of streak appearance in which the image information of the streak is included in the target image information.

The image reading device may use a configuration in which the control unit divides the region on the image indicated by the target image information into a plurality of rectangular partial regions (the seven partial image regions from the partial image region RAR to the partial image region RGR in the example described above) arranged in the main scanning direction of the image reading unit each time the target image information is read by the image reading unit, counts the number of times of streak appearance for each of the plurality of divided partial regions, and performs the process corresponding to the partial region in which the number of times of streak appearance among the plurality of partial regions exceeds the first threshold value (the threshold value Th in the example described above) as a predetermined process.

The image reading device may use a configuration in which the control unit divides the region on the image indicated by the target image information into a plurality of partial regions each time the target image information is read by the image reading unit, counts the number of times of streak appearance for each of the plurality of divided partial regions, and performs, based on the number of times of streak appearance counted for each of the plurality of partial regions and the number of times of reading of the target image information by the image reading unit, the process corresponding to the partial region in which a value based on the number of times of streak appearance and the number of times of reading among the plurality of partial regions exceeds a second threshold value (threshold value Th in the example described above) as a predetermined process.

The image reading device may use a configuration in which the image reading device includes a button that initializes the number of times of streak appearance.

In the image reading device, the control unit may use a configuration in which the control unit initializes the number of times of streak appearance.

The image reading device may use a configuration in which the image reading unit includes the glass table (glass table 152 in the example described above), the first optical system (first optical system 154 in the example described above), the second optical system (second optical system 155 in the example described above), the image sensor (image sensor 156 in the example described above), the carriage (carriage 157 in the example described above), and the motor (motor 158 in the above description), the reading target is mounted on the glass table, the first optical system is arranged under the glass table and includes the light source (light source 1541 in the example described above) that irradiates the reading target mounted on the glass table with light and the one or more reflecting members (reflecting member 1552 in the example described above) that emit the reflected light obtained by reflecting the light emitted from the light source by the reading target to the second optical system, the second optical system includes the one or more reflecting members (reflecting member 1551 and reflecting member 1552 in the example described above) that emit the reflected light incident from the first optical system to the image sensor, the image sensor converts the reflected light incident from the second optical system into an electric signal and outputs the converted electric signal as target image information to the control unit, the carriage scans the first optical system in the sub-scanning direction, and the motor drives the carriage.

The image reading device may also use a configuration in which the image reading unit includes the tray (tray 151 in the example described above), the conveying unit (conveying unit 153 in the example described above), the first optical system, the second optical system, and the image sensor. The tray is loaded with one-sheet or more-sheet reading targets, and the conveying unit conveys the reading targets loaded on the tray one by one and passes the reading targets through the image information reading region (image information reading region PA in the example described above), the first optical system includes the light source that irradiates the reading target with light in the image information reading region and the one or more reflecting members that emit the reflected light obtained by reflecting the light emitted from the light source by the reading target to the second optical system, the second optical system includes one or more reflecting members that emit the reflected light incident from the first optical system to the image sensor, and the image sensor converts the reflected light incident from the second optical system into an electric signal and outputs the converted electric signal as target image information to the control unit.

In the image reading device, if the image information of the streak is included in the target image information, the control unit may use a configuration in which the image information of the streak is removed from the target image information.

In the image reading device, the control unit may use a configuration in which the first image process based on the target image information is performed in parallel with the process of detecting whether or not the image information of the streak is included in the target image information.

In the image reading device, the control unit may use a configuration of performing a process of displaying an image (image MP in the example described above) that promotes maintenance of the image reading unit on the display(display 110 in the example described above) as a predetermined process based on the number of times of streak appearance.

It is noted that a program for realizing the functions of any components in the above-described device (for example, the image reading device 100) may be recorded on a computer-readable recording medium, and the program may be read into a computer system to be executed. It is noted that the “computer system” as used herein includes an operating system (OS) and hardware such as peripheral devices. The “computer-readable recording medium” refers to a storage device of a portable medium such as a flexible disk, a magneto-optical disk, a ROM, or a compact disk (CD)-ROM, a hard disk built in a computer system, or the like. Furthermore, the “computer-readable recording medium” may include a device of storing the program for a certain period of time like a volatile memory (RAM) inside a computer system that serves as a server or a client if a program is transmitted via a network such as the Internet or a communication circuit line such as a telephone line.

In addition, the above-described program may be transmitted from a computer system in which this program is stored in a storage device or the like to another computer system via a transmission medium or by a transmission wave in the transmission medium. Herein, the “transmission medium” for transmitting the program refers to a medium having a function of transmitting information such as a network (communication network) of the Internet or the like or a communication circuit line (communication line) of a telephone line or the like.

In addition, the above-described program may be for realizing a portion of the above-mentioned functions. Further, the above-described program may be a so-called difference file (difference program) that can realize the above-mentioned functions in combination with a program already recorded in the computer system.

While certain embodiments have been described the embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image reading device, comprising:
an image reading component that reads image information of a reading target as target image information; and
a controller that controls the image reading component,
wherein the controller detects whether or not image information of a streak not included in the reading target is included in the target image information each time the target image information is read by the image reading component and suppresses a streak occurrence based on the number of times of streak appearance in which the image information of the streak is included in the target image information.

2. The image reading device according to claim 1, wherein the controller:
divides a region on an image indicated by the target image information into a plurality of rectangular partial regions arranged in a main scanning direction of the image reading component each time the target image information is read by the image reading component,
counts the number of times of the streak appearance for each of the plurality of divided partial regions, and
suppresses the streak occurrence corresponding to the partial region in which the number of times of streak appearance exceeds a first threshold value among the plurality of partial regions.

3. The image reading device according to claim 1, wherein the controller:
divides the region on the image indicated by the target image information into a plurality of partial regions each time the target image information is read by the image reading component,
counts the number of times of the streak appearance for each of the plurality of divided partial regions, and
suppresses the streak occurrence, based on the number of times of the streak appearance counted for each of the plurality of partial regions and the number of times of reading of the target image information by the image reading component, corresponding to the partial region in which a value based on the number of times of streak appearance and the number of times of reading among the plurality of partial regions exceeds a second threshold value.

4. The image reading device according to claim 1, further comprising a button initializing the number of times of streak appearance.

5. The image reading device according to claim 1, wherein the controller initializes the number of times of streak appearance.

6. The image reading device according to claim 1, wherein
the image reading component includes a glass table, a first optical system, a second optical system, an image sensor, a carriage, and a motor,
the reading target is mounted on the glass table,
the first optical system is arranged under the glass table and includes a light source that irradiates the reading target mounted on the glass table with light and one or more reflecting members that emit reflected light obtained by reflecting the light emitted from the light source by the reading target to the second optical system,
the second optical system includes one or more reflecting members that emit the reflected light incident from the first optical system to the image sensor,
the image sensor converts the reflected light incident from the second optical system into an electric signal and outputs the converted electric signal as the target image information to the controller,
the carriage scans the first optical system in a sub-scanning direction, and
the motor drives the carriage.

7. The image reading device according to claim 1, wherein
the image reading component includes a tray, a conveying component, a first optical system, a second optical system, and an image sensor,
the tray is loaded with one-sheet or more-sheet reading targets,
the conveying component conveys the reading targets loaded on the tray one by one and passes the reading targets through an image information reading region,
the first optical system includes a light source that irradiates the reading targets with light in the image information reading region and one or more reflecting members that emit reflected light obtained by reflecting the light emitted from the light source by the reading target to the second optical system,
the second optical system includes one or more reflecting members that emit the reflected light incident from the first optical system to the image sensor, and
the image sensor converts the reflected light incident from the second optical system into an electric signal and outputs the converted electric signal to the controller as the target image information.

8. The image reading device according to claim 1, wherein, if the image information of the streak is included in the target image information, the controller removes the image information of the streak from the target image information.

9. The image reading device according to claim 1, wherein the controller performs a first image process based on the target image information in parallel with a process of detecting whether or not the image information of the streak is included in the target image information.

10. The image reading device according to claim 1, wherein the controller displays an image prompting maintenance of the image reading component on a display component based on the number of times of the streak appearance.

11. An image reading method, comprising:
an image reading component that reading image information of a reading target as target image information;
detecting whether or not image information of a streak not included in the reading target is included in the target image information each time the target image information is read; and
suppressing a streak occurrence based on the number of times of streak appearance in which the image information of the streak is included in the target image information.

12. The image reading method according to claim 11, further comprising:
dividing a region on an image indicated by the target image information into a plurality of rectangular partial regions arranged in a main scanning direction each time the target image information is read;
counting the number of times of the streak appearance for each of the plurality of divided partial regions; and
suppressing the streak occurrence corresponding to the partial region in which the number of times of streak appearance exceeds a first threshold value among the plurality of partial regions.

13. The image reading method according to claim 11, further comprising:
dividing the region on the image indicated by the target image information into a plurality of partial regions each time the target image information is read;
counting the number of times of the streak appearance for each of the plurality of divided partial regions; and
suppressing the streak occurrence, based on the number of times of the streak appearance counted for each of the plurality of partial regions and the number of times of reading of the target image information, corresponding to the partial region in which a value based on the number of times of streak appearance and the number of times of reading among the plurality of partial regions exceeds a second threshold value.

14. The image reading method according to claim 11, further comprising:
initializing the number of times of streak appearance.

15. The image reading method according to claim 11, further comprising:
mounting the reading target on a glass table;
arranging a first optical system under the glass table that includes a light source that irradiates the reading target mounted on the glass table with light and one or more reflecting members that emit reflected light obtained by reflecting the light emitted from the light source by the reading target to a second optical system including one or more reflecting members that emit the reflected light incident from the first optical system to an image sensor;
the image sensor converting the reflected light incident from the second optical system into an electric signal and outputting the converted electric signal as the target image information;
scanning the first optical system in a sub-scanning direction; and
driving a carriage.

16. The image reading method according to claim 11, further comprising:
loading a tray with one-sheet or more-sheet reading targets;
the conveying component conveying the reading targets loaded on the tray one by one and passing the reading targets through an image information reading region;
irradiating the reading targets using a first optical system including a light source with light in the image information reading region and one or more reflecting members that emit reflected light obtained by reflecting the light emitted from the light source by the reading target to a second optical system including one or more reflecting members that emit the reflected light incident from the first optical system to an image sensor; and
converting the reflected light incident from the second optical system into an electric signal and outputting the converted electric signal as the target image information.

17. The image reading method according to claim 11, further comprising:
if the image information of the streak is included in the target image information, removing the image information of the streak from the target image information.

18. The image reading method according to claim 11, further comprising:
performing a first image process based on the target image information in parallel with a process of detecting whether or not the image information of the streak is included in the target image information.

19. The image reading method according to claim 11, further comprising:
displaying an image prompting maintenance on a display component based on the number of times of the streak appearance.

20. A multifunctional peripheral, comprising:
an image forming component; and
image reading device, comprising:
an image reading component that reads image information of a reading target as target image information; and
a controller that controls the image reading component,
wherein the controller detects whether or not image information of a streak not included in the reading target is included in the target image information each time the target image information is read by the image reading component and suppresses a streak occurrence based on the number of times of streak appearance in which the image information of the streak is included in the target image information.
